(19) United States
(12) Patent Application Publication
(10) Pub. No.: US 2015/0205956 A1
(43) Pub. Date: Jul. 23, 2015

(54) INFORMATION PROCESSING APPARATUS, INFORMATION PROCESSING METHOD, AND PROGRAM

(71) Applicant: Mitsubishi Electric Corporation, Tokyo (JP)

(72) Inventors: Shoji Sakurai, Tokyo (JP); Kiyoto Kawauchi, Tokyo (JP)

(73) Assignee: Mitsubishi Electric Corporation, Tokyo (JP)

(21) Appl. No.: 14/420,079

(22) PCT Filed: Aug. 29, 2013
(86) PCT No.: PCT/JP2013/073197

§ 371 Date: Feb. 6, 2015

(30) Foreign Application Priority Data
Sep. 19, 2012 (JP) 2012-205836

(51) Int. Cl. G06F 21/55

(52) U.S. Cl. CPC G06F 21/554; G06F 2221/034

(57) ABSTRACT

A progress status of an attack on an information system possibly carried out is visualized to display a warning to a user, without using a correlation rule. A table storage stores a past case table indicating a phase string obtained by concatenating phase values indicating attack progress degrees according to an event occurrence pattern in a past case. A phase string generator obtains a phase string by concatenating phase values according to the occurrence pattern of events that have occurred in the information system. A similarity degree calculator calculates a similarity degree between the obtained phase string and the phase string indicated in the past case table. An attack status visualization unit visualizes the progress status of the attack on the information system, based on the obtained phase string and a result of calculation of the similarity degree by the similarity degree calculator.

### TECHNICAL FIELD

The present invention relates to a technology for visualizing a threat to an information system.

### BACKGROUND ART

In a conventional threat visualization method (disclosed in Patent Literature 1, for example), occurrence of a threat is determined based on a correlation rule that defines the occurrence order of events considered to be the threat, and the events matching the correlation rule are displayed on a screen to warn a user.

### CITATION LIST

### Patent Literature

Patent Literature 1: JP 2004-537075

### SUMMARY OF INVENTION

### Technical Problem

In the conventional threat visualization method, there is a problem that the screen for warning is not displayed to the user unless the events defined in the correlation rule are all detected.

The events defined in the correlation rule are abnormal events considered to be malicious behaviors, which may occur in a network device, a server, and a computer such as a PC (Personal Computer).

Such events are detected by a sensor, for example, and the detected events are notified to an apparatus whose screen is monitored by the user. Detection omission, however, may occur in the detection of these abnormal events by the sensor.

Consequently, in the conventional threat visualization method, there is a problem that, though an attack on an information system is actually being carried out, the correlation rule is not satisfied due to detection omission of one event, so that a warning is not displayed to the user.

A main object of the present invention is to solve the problem as mentioned above. It is the main object of the present invention to visualize a progress status of an attack and display a warning to a user without using a correlation rule when the attack on an information system is possibly being carried out.

### Solution to Problem

An information processing apparatus according to the present invention may include:

an attack event table storage unit that stores an attack event table indicating, for each of a plurality of events caused from an attack on an information system, a progress degree of the attack at a time when each event occurs;

an attack event progress degree string table storage unit that stores an attack event progress degree string table indicating a character string as an attack event progress degree string, the character string being obtained by concatenating the progress degrees of corresponding events according to an occurrence pattern of events in an attack sequence;

an occurred event progress degree string derivation unit that concatenates the progress degrees of corresponding events according to the occurrence pattern of the events that have occurred in the information system, and derives an occurred event progress degree string that is a character string;

a similarity degree calculation unit that calculates a similarity degree between the occurred event progress degree string derived by the occurred event progress degree string derivation unit and the attack event progress degree string indicated in the attack event progress degree string table; and

an attack status visualization unit that visualizes a progress status of the attack on the information system, based on the occurred event progress degree string obtained by the occurred event progress degree string derivation unit and a result of calculation of the similarity degree by the similarity degree calculation unit.

### Advantageous Effects of Invention

In the present invention, the occurred event progress degree string is derived according to the occurrence pattern of the events that have occurred in the information system, and the similarity degree between the occurred event progress degree string and the attack event progress degree string is calculated.

Further, in the present invention, the progress status of the attack on the information system is visualized, based on the occurred event progress degree string and the result of calculation of the similarity degree.

Consequently, according to the present invention, use of a correlation rule is not required, so that a situation may be avoided where a warning is not displayed to a user because the correlation rule is not satisfied due to detection omission of one event, and therefore the warning can be displayed to the user when the attack is possibly being carried out.

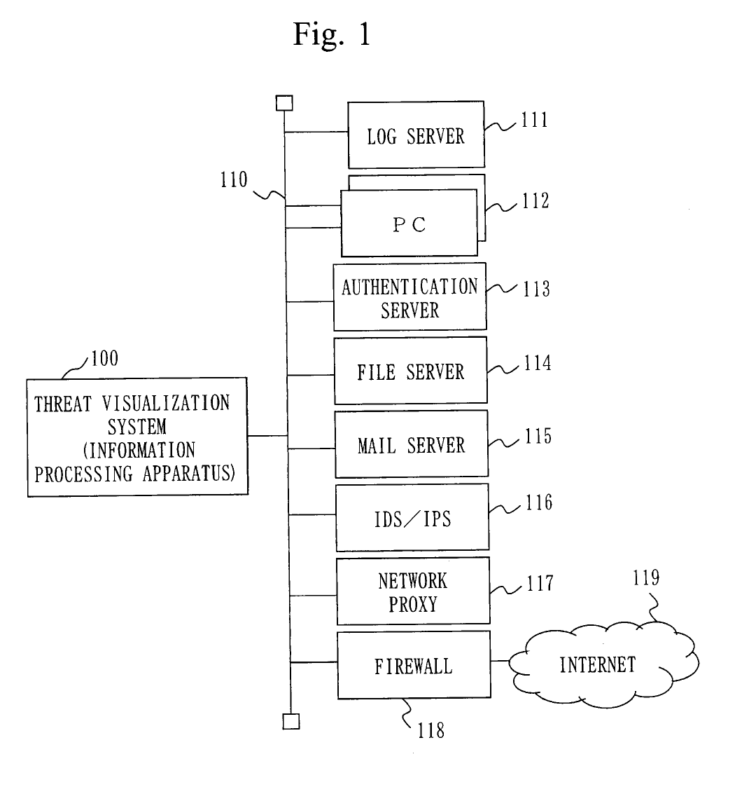

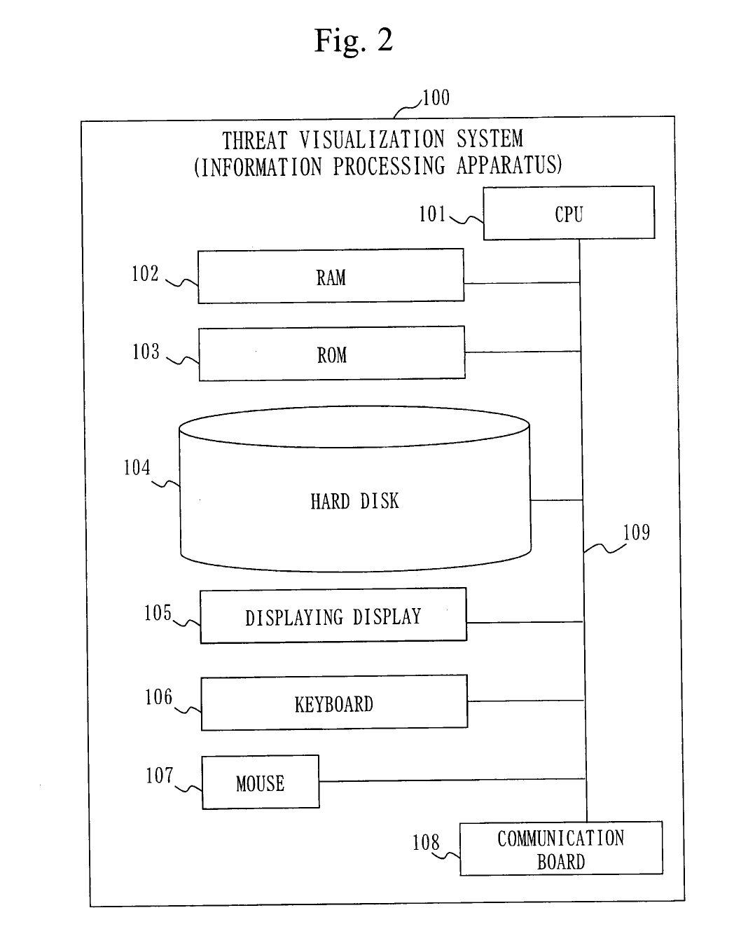

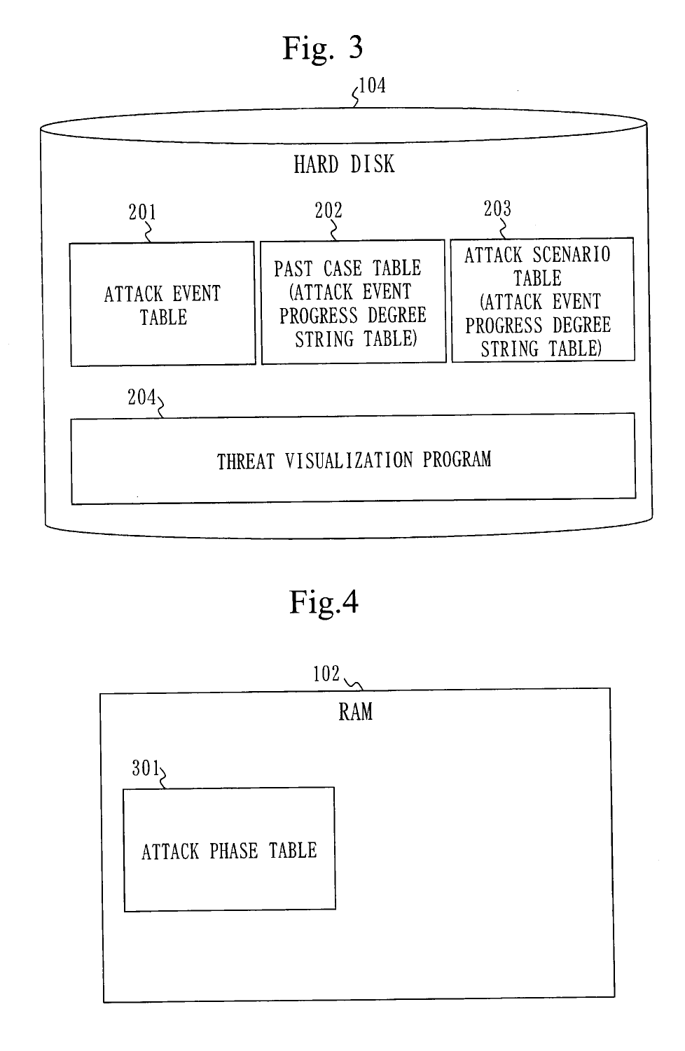

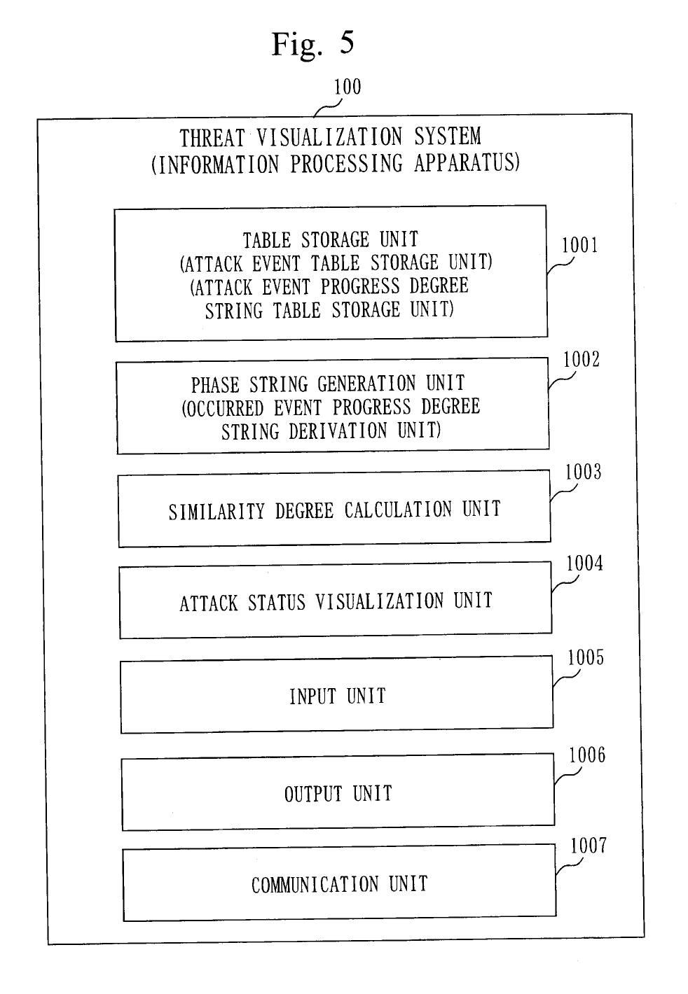

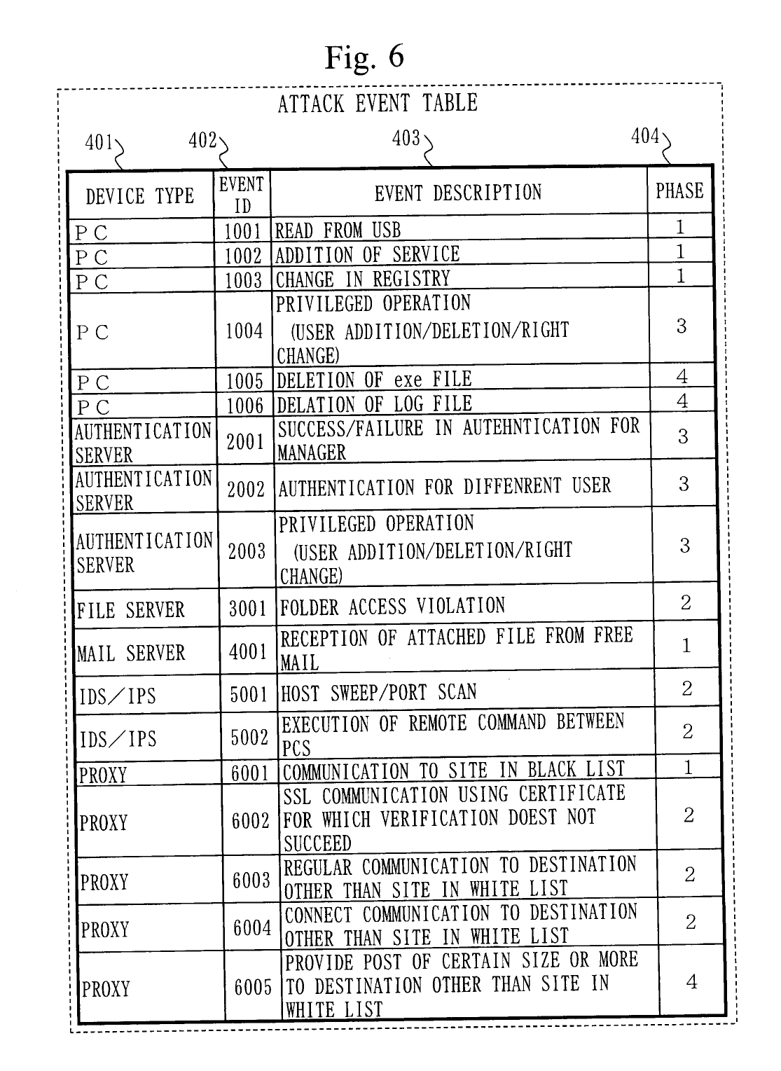

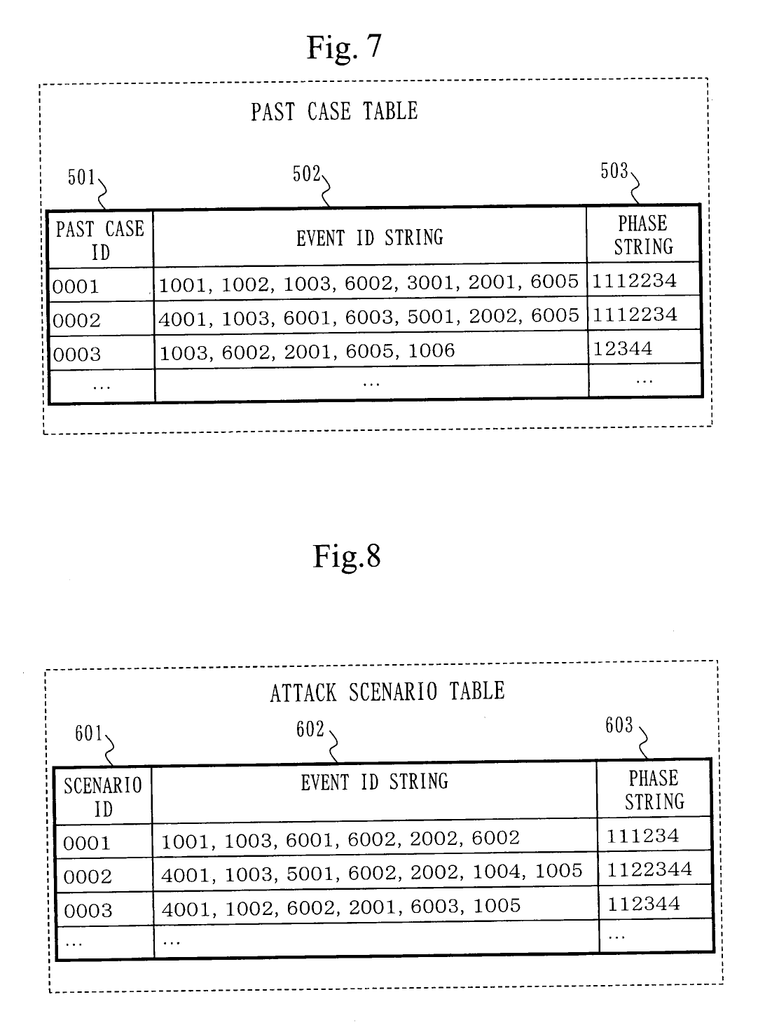

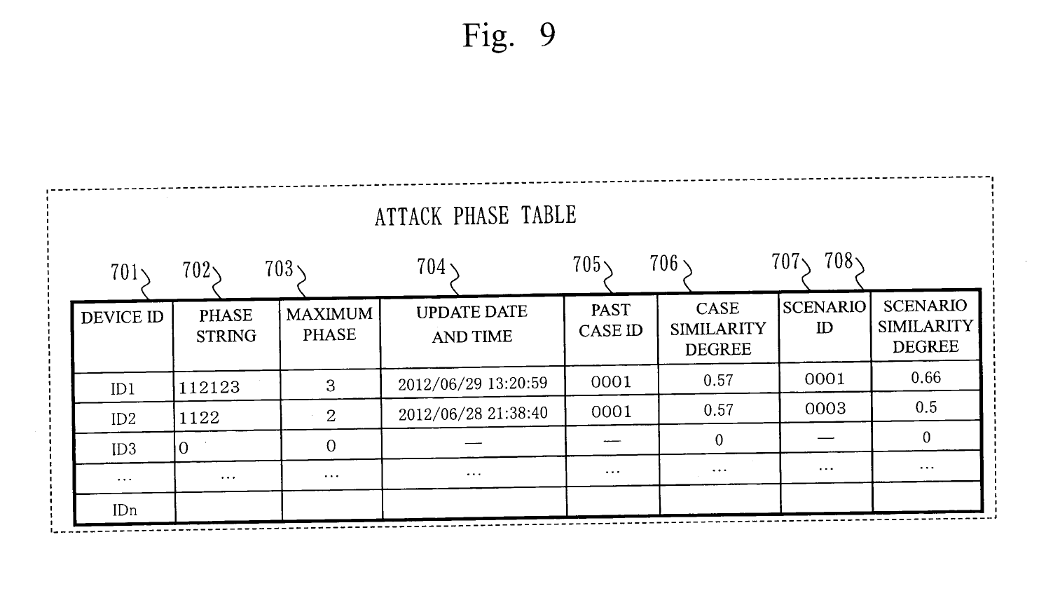

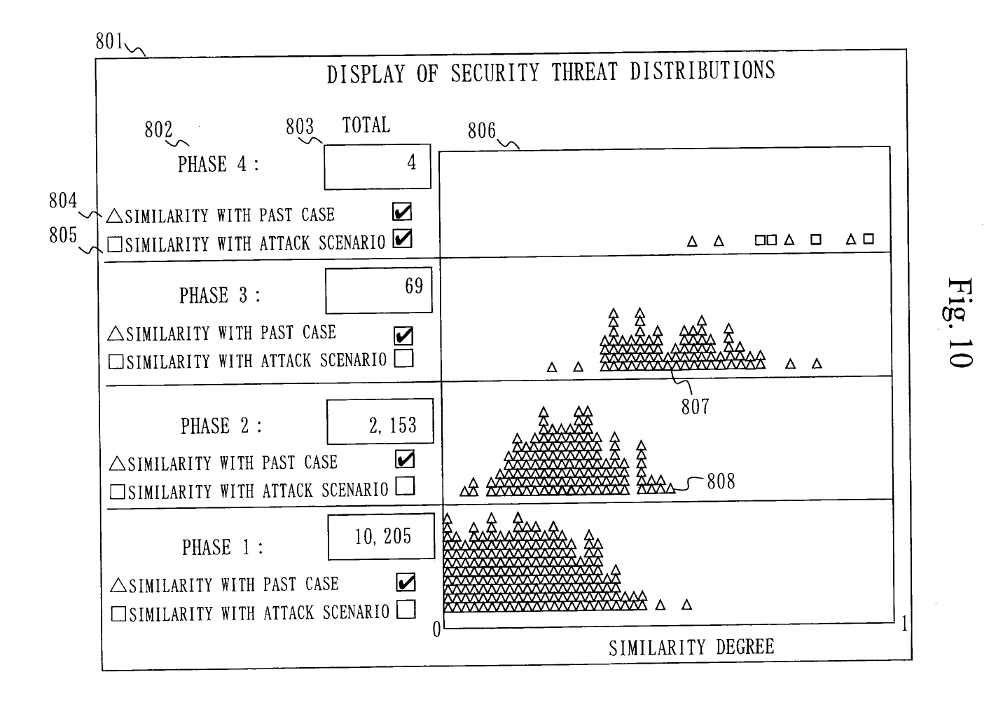

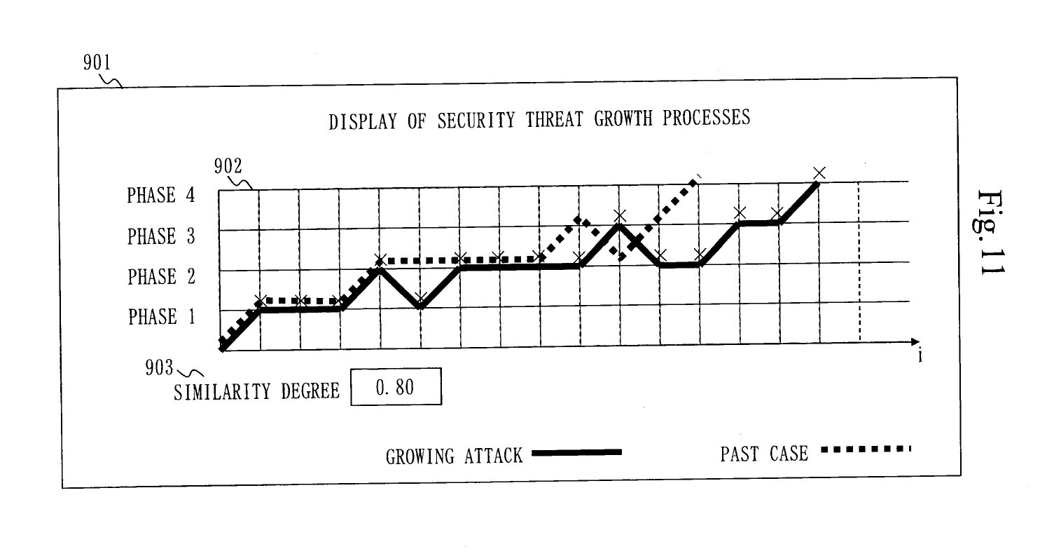

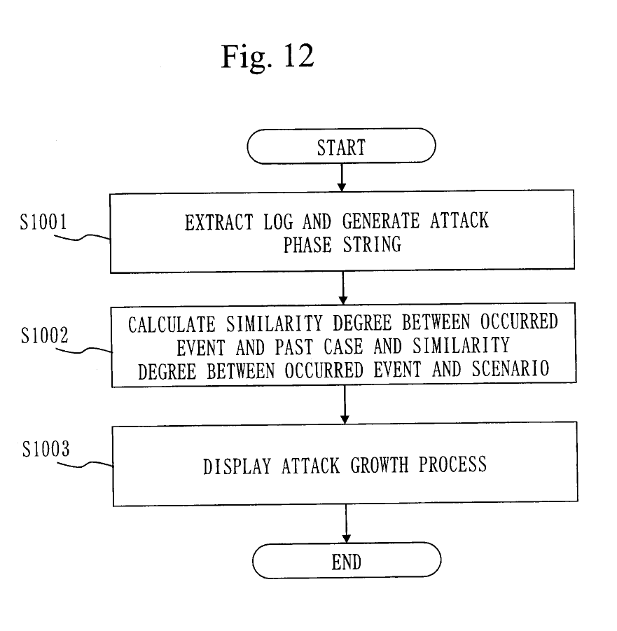

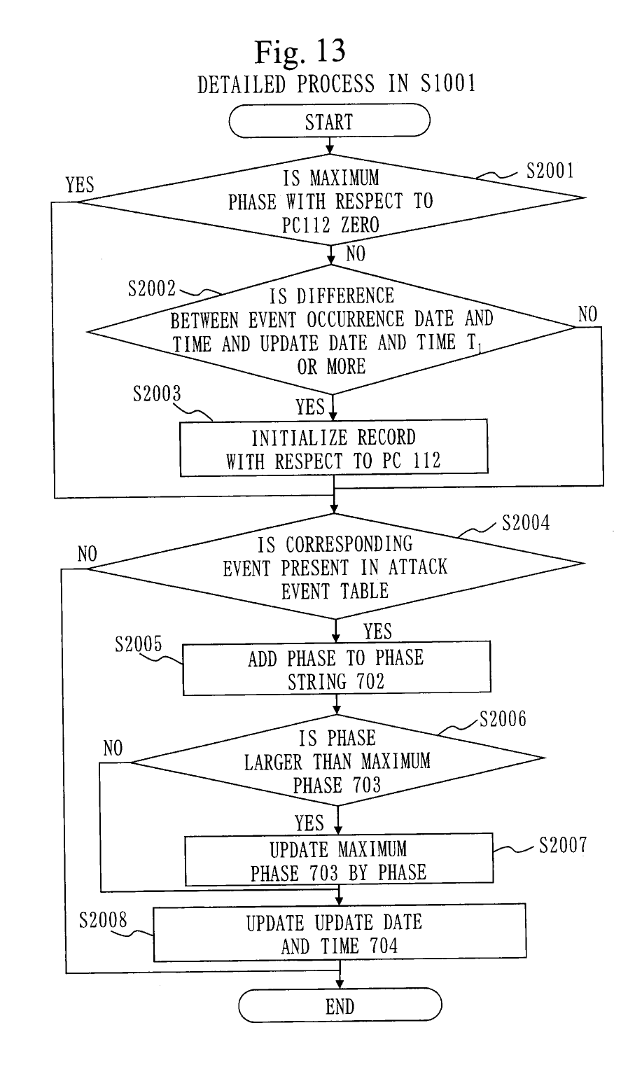

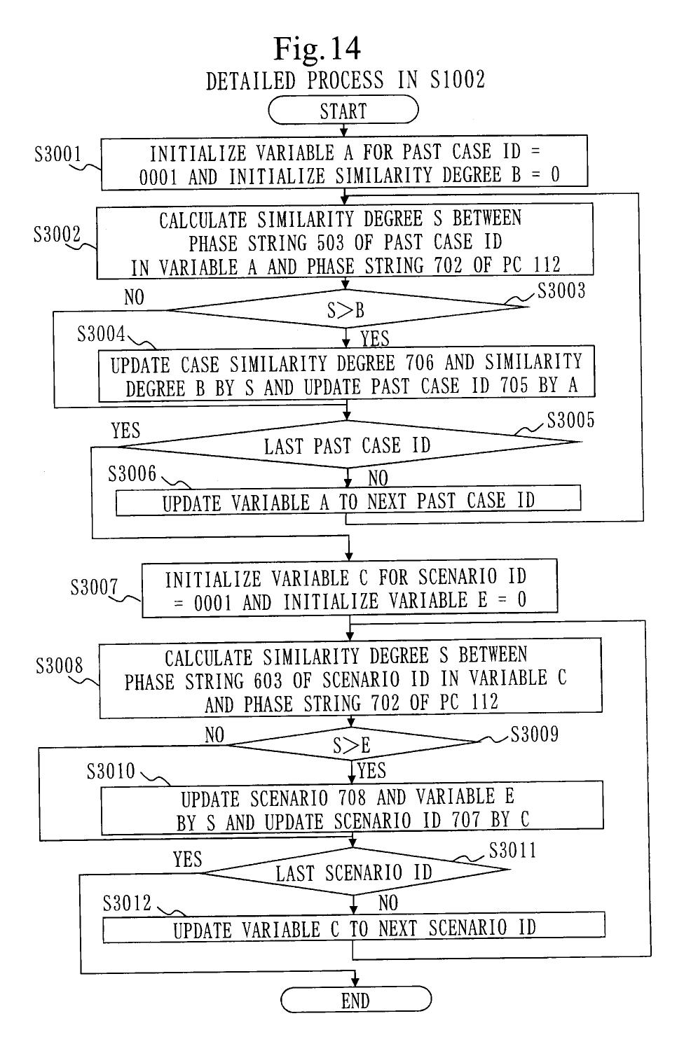

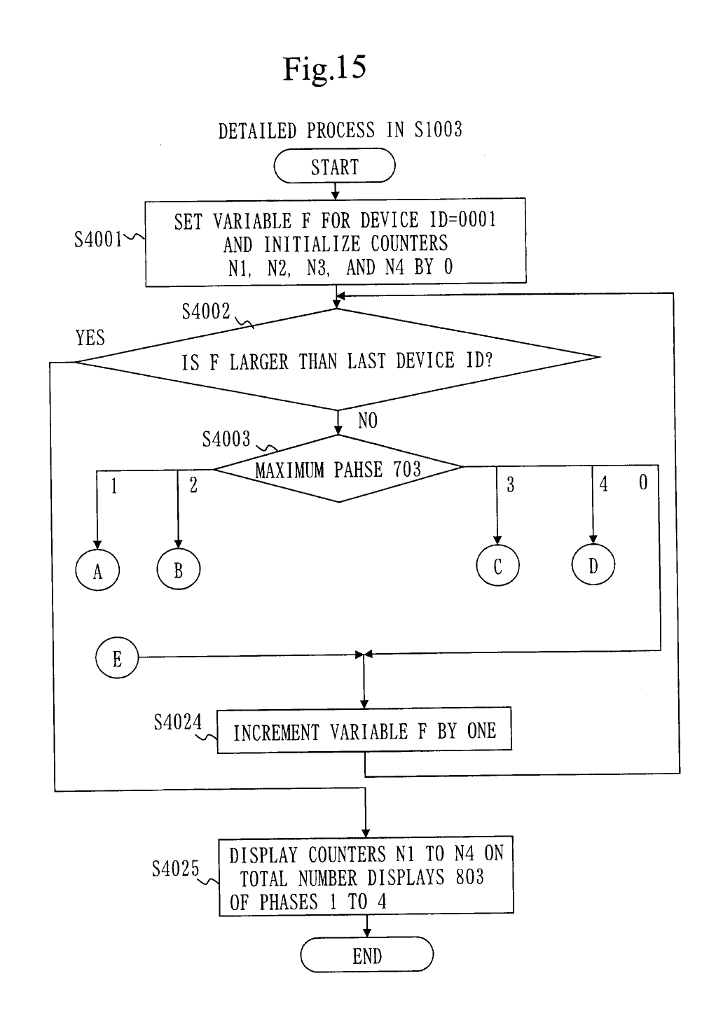

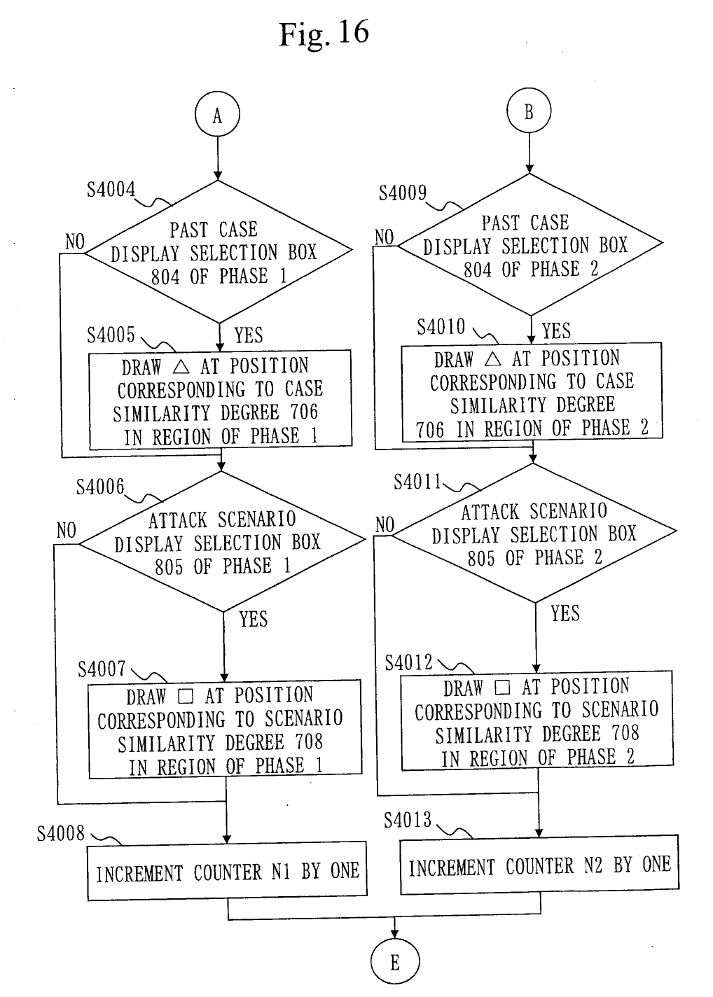

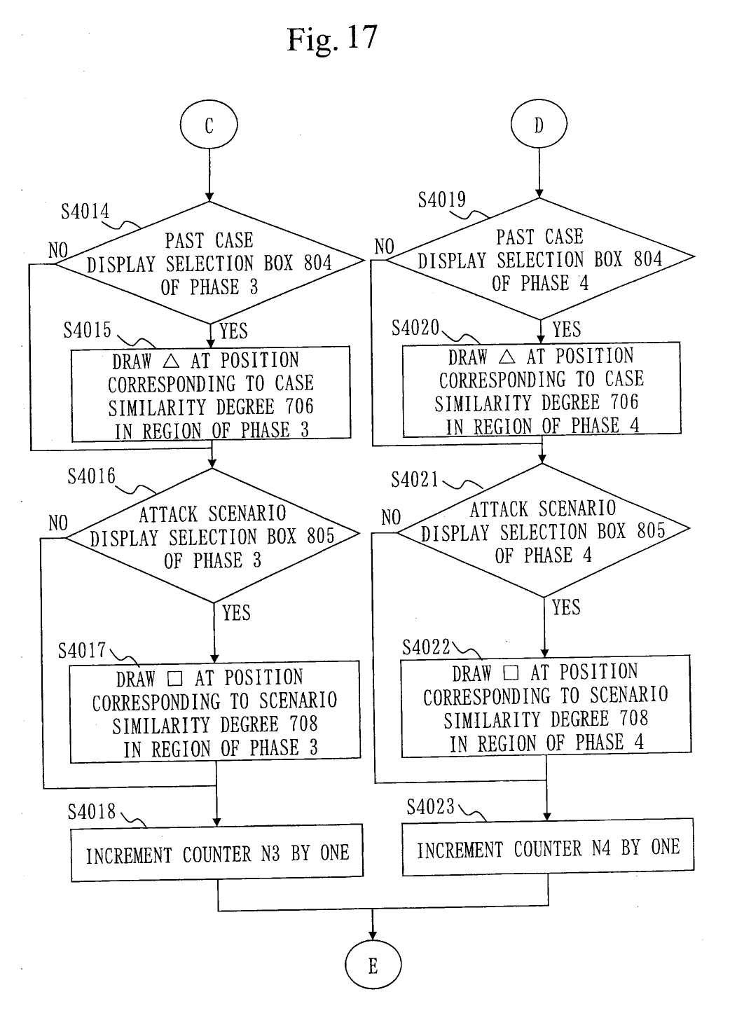

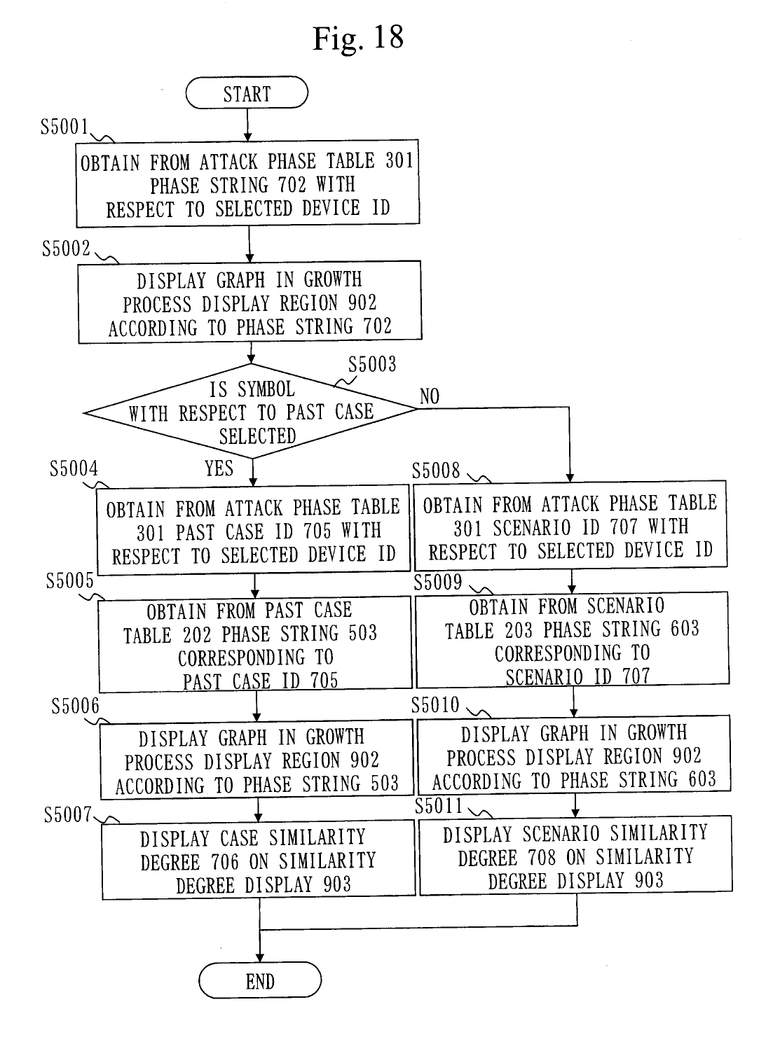

### BRIEF DESCRIPTION OF DRAWINGS

[FIG. 1] is a diagram illustrating a configuration example of an information system according to a first embodiment.

[FIG. 2] is a diagram illustrating a hardware configuration of a threat visualization system according to the first embodiment.

[FIG. 3] is a diagram illustrating an example of data in a hard disk of the threat visualization system according to the first embodiment.

[FIG. 4] is a diagram illustrating an example of data in a RAM of the threat visualization system according to the first embodiment.

[FIG. 5] is a diagram illustrating an example of a functional configuration of the threat visualization system according to the first embodiment.

[FIG. 6] is a table illustrating an example of an attack event table according to the first embodiment.

[FIG. 7] is a table illustrating an example of a past case table according to the first embodiment.

[FIG. 8] is a table illustrating an example of an attack scenario table according to the first embodiment.

[FIG. 9] is a table illustrating an example of an attack phase table according to the first embodiment.

[FIG. 10] is a diagram illustrating an example of a security threat distribution screen according to the first embodiment.

[FIG. 11] is a diagram illustrating an example of a security growth process display screen according to the first embodiment.

[FIG. 12] is a flowchart diagram illustrating an outline of operation of the threat visualization system according to the first embodiment.

[FIG. 13] is a flowchart diagram illustrating details of the operation of the threat visualization system according to the first embodiment.

[FIG. 14] is a flowchart diagram illustrating details of the operation of the threat visualization system according to the first embodiment.

[FIG. 15] is a flowchart diagram illustrating details of the operation of the threat visualization system according to the first embodiment.

[FIG. 16] is a flowchart diagram illustrating details of the operation of the threat visualization system according to the first embodiment.

[FIG. 17] is a flowchart diagram illustrating details of the operation of the threat visualization system according to the first embodiment.

[FIG. 18] is a flowchart diagram illustrating details of the operation of the threat visualization system according to the first embodiment.

### DESCRIPTION OF EMBODIMENTS

### Embodiment 1

In this embodiment, a description will be directed to a configuration in which, even if detection omission of an individual abnormal event has occurred, a warning is displayed to a user when an attack is possibly being carried out.

FIG. 1 shows a configuration example of an information system according to this embodiment.

The information system according to this embodiment is configured with a threat visualization system 100, a LAN (Local Area Network) 110, a log server 111, PCs 112, an authentication server 113, a file server 114, a mail server 115, an IDS (Intrusion Detection System)/IPS (Intrusion Prevention System) 116, a network proxy 117, and a firewall 118, for example.

The threat visualization system 100 is a computer that visualizes a threat to the information system, and corresponds to an example of an information processing apparatus.

The threat visualization system 100 is connected to the LAN 110.

The log server 111, the PCs 112, the authentication server 113, the file server 114, the mail server 115, the IDS/IPS 116, the network proxy 117, and the firewall 118 are connected to the LAN 110.

The firewall 118 is connected to an Internet 119.

Usually, a plurality of the PCs 112 are present.

Each PC 112 corresponds to an example of a terminal device.

As illustrated in FIG. 2, the threat visualization system 100 includes a CPU 101, a RAM (Random Access Memory) 102, a ROM (Read Only Memory) 103, a hard disk 104, a displaying display 105, a keyboard 106, a mouse 107, and a communication board 108. These are connected to a bus 109.

The threat visualization system 100 includes a functional configuration illustrated in FIG. 5.

Referring to FIG. 5, a table storage unit 1001 stores various tables used for visualizing a threat to the information system.

Details of the various tables will be described later.

The table storage unit 1001 corresponds to an example of an attack event table storage unit and an attack event progress degree string table storage unit.

The table storage unit 1001 is implemented by the RAM 102 and the hard disk 104 in FIG. 2.

According to the occurrence pattern of events that have occurred in the information system, a phase string generation unit 1002 concatenates phase values that indicate progress degrees of the events, thereby generating a phase string (occurred event progress degree string).

The phase string generation unit 1002 corresponds to an example of an occurred event progress degree derivation unit.

The phase string generation unit 1002 is constituted as a program, for example, and the program that implements the phase string generation unit 1002 is executed by the CPU 101 in FIG. 2.

A similarity degree calculation unit 1003 calculates a similarity degree between the phase string (occurred event progress degree string) obtained by the phase string generation unit 1002 and a phase string indicated in a past case table or an attack scenario table that will be described later.

The similarity degree calculation unit 1003 is also constituted as a program, for example, and the program that implements the similarity degree calculation unit 1003 is executed by the CPU 101 in FIG. 2.

An attack status visualization unit 1004 visualizes a progress status of an attack on the information system, based on the phase string obtained by the phase string generation unit 1002 and a result of calculation of the similarity degree by the similarity degree calculation unit 1003.

The attack status visualization unit 1004 is also constituted as a program, for example, and the program that implements the attack status visualization unit 1004 is executed by the CPU 101 in FIG. 2.

An input unit 1005 inputs various data from a user of the threat visualization system 100.

The input unit 1005 is implemented by the keyboard 106 and the mouse 107 in FIG. 2.

An output unit 1006 displays various data to the user of the threat visualization system 100.

The output unit 1006 displays the progress status of the attack visualized by the attack status visualization unit 1004 to the user, for example.

The output unit 1006 is implemented by the displaying display 105 in FIG. 2.

A communication unit 1007 communicates with other apparatuses through the LAN 110.

The communication unit 1007 receives log data from the log server 111, for example.

The communication unit 1007 is implemented by the communication board 108 in FIG. 2.

FIG. 3 illustrates tables stored in the hard disk 104 in FIG. 2.

An attack event table 201, a past case table 202, an attack scenario table 203, and a threat visualization program 204 are stored in the hard disk 104.

The threat visualization program 204 is a program that implements the phase string generation unit 1002, the similarity degree calculation unit 1003, and the attack status visualization unit 1004 in FIG. 5.

The threat visualization program 204 is loaded onto the RAM 102. The CPU 101 reads the threat visualization program 204 from the RAM 102, and then executes the threat visualization program 204, thereby implementing the functions of the phase string generation unit 1002, the similarity degree calculation unit 1003, and the attack status visualization unit 1004 in FIG. 5.

Though not illustrated in FIG. 3, the hard disk 104 stores an OS (Operating System). The CPU 101 executes the threat visualization program 204, using the OS.

FIG. 4 illustrates a table generated on the RAM 102.

An attack phase table 301 is generated on the RAM 102 by the threat visualization program 204.

FIG. 6 illustrates a configuration of the attack event table 201.

The attack event table 201 is a table in which, when each of a plurality of events caused from an attack on the information system has occurred, a progress degree of the attack is indicated.

As illustrated in FIG. 6, the attack event table 201 includes a device type 401, an event ID 402, an event description 403, and a phase 404, for each event caused from the attack.

The device type 401 indicates a device (such as the PC112, or the authentication server 113) from which the event has occurred.

An identifier for each event is given in the field of the event ID 402.

An outline of each event is given in the field of the event description 403.

The value of a phase representing a progress degree or a stage of the attack is given in the field of the phase 404.

To take an example, the event to be observed when the attack is in the state of “intrusion” may be defined to be a phase “1”, the event to be observed when the attack is in the state of “search” may be defined to be a “phase 2”, the event to be observed when the attack is in the state of “privilege elevation” may be defined to be a “phase 3”, and the event when the attack is in the state of “information theft” may be defined to be a “phase 4”.

FIG. 7 illustrates a configuration of the past case table 202.

The past case table 202 is a table in which events that occurred in each past case of an attack (attack sequence) are indicated in the order of occurrence.

The past case table 202 includes a past case ID 501, an event ID string 502, and a phase string 503.

An identifier for the past case is given in the field of the past case ID 501.

Event IDs for the events that occurred in the past case of the attack are given in the field of the event ID string 502 in the order of occurrence.

A character string (phase string) is given in the field of the phase string 503. The character string (phase string) is obtained by concatenating the values in the phase 404 corresponding to the respective event IDs given in the field of the event ID string 502.

The character string given in the field of the phase string 503 corresponds to an example of an attack event progress degree string.

The past case table 202 corresponds to an example of an attack event progress degree string table.

FIG. 8 illustrates a configuration of the attack scenario table 203.

The attack scenario table 203 is a table in which events assumed to occur in each assumed attack (attack sequence) are indicated in the order of occurrence.

An attack which does not actually occur but whose occurrence is assumed, is called an attack scenario.

An attack obtained by transformation of a part of an attack that actually occurred in the past may be used as the attack scenario, for example.

The attack scenario table 203 includes a scenario ID 601, an event ID string 602, and a phase string 603.

An identifier for each attack scenario is given in the field of the scenario ID 601.

Event IDs for the events whose occurrence is assumed when the attack is carried out are given in the field of the event ID string 602 in the order of occurrence of the events.

A character string (phase string) is given in the field of the phase string 603. The character string (phase string) is obtained by concatenating the values in the phase 404 corresponding to the respective event IDs given in the field of the event ID string 602 in the order of occurrence.

The character string given in the field of the phase string 603 corresponds to an example of an attack event progress degree string.

The attack scenario table 203 corresponds to an example of an attack event progress degree string table.

FIG. 9 illustrates a configuration of the attack phase table 301.

The attack phase table 301 is a table generated by the phase string generation unit 1002 according to the occurrence pattern of events that have occurred in the information system. The attack phase table 301 is generated after analyzing log data from the log server 111 by the phase string generation unit 1002.

The attack phase table 301 includes a device ID 701, a phase string 702, a maximum phase 703, an update date and time 704, a past case ID 705, a case similarity degree 706, a scenario ID 707, and a scenario similarity degree 708.

An IP (Internet Protocol) address of each PC 112 is usually given in the field of the device ID 701 (an address for the device ID 701 is not limited to the IP address, and a MAC (Media Access Control) address or the like may be used for the device ID 701 as long as the PC can be uniquely identified).

A character string obtained by concatenating the values in the phase 404 corresponding to the respective events extracted by the log data analysis in the order of occurrence is given in the field of the phase string 702.

A maximum one of the values in the phase string 702 is given in the field of the maximum phase 703.

A date and time described in the log data that has been last referred to by the phase string generation unit 1002 is given in the field of the update date and time 704.

The past case ID 501 of the past case, based on which a similarity degree shown in the field of the case similarity degree 706 has been calculated, is given in the field of the past case ID 705.

A maximum one of similarity degrees of the past cases calculated by the similarity degree calculation unit 103 with respect to the phase string 702 is given in the field of the case similarity degree 706.

The scenario ID 601 of the attack scenario, based on which a similarity degree indicated in the field of the scenario similarity degree 708 has been calculated, is given in the field of the scenario ID 707.

A maximum one of similarity degrees of the attack scenarios calculated by the similarity degree calculation unit 1003 with respect to the phase string 702 is given in the field of the scenario similarity degree 708.

FIG. 10 illustrates a screen example of a security threat distribution screen.

A security threat distribution screen 801 includes a phase display 802, a total number display 803, a past case display selection box 804, an attack scenario display selection box 805, and a similarity degree display region 806.

The phase display 802 displays the name of each phase.

The total number display 803 displays the total number of the devices belonging to the phase.

The past case display selection box 804 is a check box for selecting display of similarity with one of the past cases.

The attack scenario display selection box 805 is a check box for selecting display of similarity with one of the attack scenarios.

The similarity degree display region 806 displays one or more of the devices belonging to each phase according to the similarity degree.

The security threat distribution screen 801 is generated by the attack status visualization unit 1004 and is displayed by the output unit 1006.

Reference symbol Δ indicates a similarity degree with the past case, and reference symbol □ indicates a similarity degree with the attack scenario, in the similarity degree display region 806.

Each of the reference symbols Δ and □ indicates the PC 112.

The horizontal axis of the similarity degree display region 806 indicates a similarity degree value (0.0 to 1.0 inclusive), while the vertical axis of the similarity degree display region 806 indicates the number of the PCs 112.

On the security threat distribution screen 801, for each device ID in the attack phase table (in FIG. 9), in the similarity degree display region 806 of the phase corresponding to the value of the maximum phase 703, the reference symbol Δ is plotted at a position corresponding to the value of the case similarity degree 706 and the reference symbol □ is plotted at a position corresponding to the value of the scenario similarity degree 708.

In the record (device ID: ID1) at a first row in FIG. 9, for example, the maximum phase 703 is “3”, and the case similarity degree 706 is “0.57”. Thus, the reference symbol Δ is plotted at a position indicated by reference sign 807 in FIG. 10 (since the attack scenario display selection box 805 of the phase 3 is not checked in FIG. 10, the reference symbol □ for the scenario similarity degree 708 of “0.66” is not displayed).

Similarly, in the record (device ID: ID2) at a second row in FIG. 9, the maximum phase 703 is “2”, and the case similarity degree 706 is “0.57”. Thus, the reference symbol Δ is plotted at a position indicated by reference sign 808 in FIG. 10, for example (since the attack scenario display selection box 805 of the phase 2 is not checked in FIG. 10, the reference symbol □ for the scenario similarity degree 708 of “0.5” is not displayed).

By plotting a relationship between the maximum phase 703 and the maximum similarity degree (the case similarity degree 706 and/or the scenario similarity degree 708) extracted for each PC 112, and by displaying the graphs indicating distributions of the maximum phase 703 and the maximum similarity degree with respect to the plurality of the PCs 112 in this manner, the progress status of the attack on the information system may be visualized.

FIG. 11 illustrates a screen example of a security growth process display screen.

A security growth process display screen 901 includes a growth process display region 902 and a similarity degree display 903. The growth process display region 902 displays an occurrence process of events with respect to a specific one of the devices together with the occurrence process of the similar past case. The similarity degree display 903 displays a similarity degree between these occurrence processes.

That is, on the security growth process display screen 901, a phase value transition in the phase string 702 of a specific one of the PCs 112 and a phase value transition in the phase string 603 of the past case indicated in the past case ID 705 are graph-displayed in the growth process display region 902.

The value of the case similarity degree 706 of the PC 112 is displayed on the similarity degree display 903.

FIG. 9 illustrates an example where the occurrence process of the events with respect to the specific device is displayed together with the occurrence process of the similar past case. The occurrence process of the events with respect to the specific device may be displayed together with the occurrence process of the similar attack scenario.

The progress status of the attack on the information system is visualized on the security growth process display screen 901 by such a method.

Next, operation will be described.

A general user accesses the authentication server 113 using the PC 112 to perform authentication based on a user ID and a password, and then accesses the file server 114.

The user accesses the mail server 115 using the PC 112 to read or write a mail.

The user accesses the Internet 119 through the network proxy 117 and further through the firewall 118, using the PC 112.

The PC 112, the authentication server 113, the file server 114, the mail server 115, the network proxy 117, and the firewall 118 each output predetermined log data (hereinafter also referred to just as a log) when these operations are performed by the general user.

The IDS/IPS 116 outputs predetermined log data when communication of a packet matching a predetermined condition is observed on the LAN 110.

The log data of these devices are transmitted to the log server 111, and are recorded in the log server 111 according to the time series of times described in the log data.

In the threat visualization system 100, the threat visualization program 204 stored in the hard disk 104 is loaded from the hard disk 104 onto the RAM 102 through the bus 109, and is then executed by the CPU 101.

The threat visualization program 204 sequentially extracts the logs recorded in the log server 111 according to the time series through the LAN 110.

The logs from the log server 111 each include an event occurrence date and time, a log type, an event ID, a device ID, and an event description of an individual occurred event recorded therein.

The event occurrence date and time indicates a date and time on which the event recorded in the log has occurred.

The log type indicates the type of the device in which the event recorded in the log has occurred.

The event ID indicates an ID whereby the type of the individual occurred event may be uniquely identified.

The device ID indicates an ID whereby the device in which the event has occurred is uniquely identified.

The log that has recorded passage of a packet or the like includes two device IDs, which are the device ID of a transmission source and the device ID of a transmission destination.

The event description indicates a description of details of the individual occurred event.

FIG. 12 illustrates a basic flow of processes to be executed by the threat visualization system 100 for each occurred event recorded in each of the extracted logs.

The processes in steps S1001 to S1003 illustrated in FIG. 12 are repetitively executed in a cycle of five minutes, for example.

The cycle of five minutes is just an exemplification, and an arbitrary cycle may be set, according to the size of the information system and a security policy.

In flowcharts in FIGS. 12 to 18, the procedure of the processes is described in the form of operations of the phase string generation unit 1002, the similarity degree calculation unit 1003, and the attack status visualization unit 1004.

Each variable value and each counter value described with reference to FIGS. 13 and 18 are managed by a register of the CPU 101 or the RAM 102, for example.

In step S1001, the phase string generation unit 1002 generates an attack phase string (details of which will be described later) for the PC 12, based on the occurred event recorded in the extracted log.

Next, in step S1002, the similarity degree calculation unit 1003 calculates a similarity degree between the attack phase string generated in step S1001 and the past case, and calculates a similarity degree between the attack phase string generated in step S1001 and the attack scenario.

Further, in step S1003, the attack status visualization unit 1004 displays the attack phase string generated in step S1001 and the similarity degrees calculated in step S1002 on the displaying display 105.

FIG. 13 describes the process in step S1001 in detail.

In step S2001, the phase string generation unit 1002 determines whether the maximum phase 703 with respect to the PC 112 corresponding to the device ID associated with the occurred event recorded in the extracted log is zero.

If the maximum phase 703 is zero in step S2001, the phase string generation unit 1002 executes step S2004.

If the maximum phase 703 is not zero in step S2001, the phase string generation unit 1002 determines whether a difference between the event occurrence date and time and the update date and time 704 with respect to the PC 112 is T₁ or more, in step S2002.

If the difference between the dates and times is T₁ or more in step S2002, the phase string generation unit 1002 initializes the record in the attack phase table 301 with respect to the PC 112.

Specifically, the phase string generation unit 1002 updates the phase string 702 to 0, updates the maximum phase 703 to 0, and updates the update date and time 704 to no record (−).

If the difference between the dates and times is less than T₁ in step S2002, the phase string generation unit 1002 executes step S2004.

In step S2004, the phase string generation unit 1002 determines based on the event ID 402 whether an event ID matching the event ID of the occurred event recorded in the extracted log is present in the attack event table 201.

If the event ID matching the event ID of the occurred event recorded in the log is not present in the attack event table 201 in step S2004, the phase string generation unit 1002 finishes the process.

On the other hand, if the event ID matching the event ID of the occurred event recorded in the log is present in the attack event table 201 in step S2004, the phase string generation unit 1002 adds the phase value of the corresponding event to the end of the phase string 702 in the record in the attack phase table 301 with respect to the PC 112, in step S2005.

Next, in step S2006, the phase string generation unit 1002 compares the phase value of the event mentioned before and obtained from the attack event table 201 and the maximum phase 703 in the record in the attack phase table 301 with respect to the PC 112.

If the phase value is not larger than the maximum phase 703 in step S2006, the phase string generation unit 1002 updates the update date and time 704 in the record with respect to the PC 112 in the attack phase table 301, by replacing the update and time 704 with the event occurrence date and time of the occurred event, in step S2008, and then finishes the process.

On the other hand, if the phase value is larger than the maximum phase 703 in step S2006, the phase string generation unit 1002 updates the maximum phase 703 in the record with respect to the PC 112 in the attack phase table 301, by replacing the maximum phase 703 with this phase value in step S2007, and then executes step S2008.

FIG. 14 describes the process in step S1002 in detail.

In step S3001, the similarity degree calculation unit 1003 initializes a variable A for storing the past case ID 501 in the past case table 202 by 0001 that is the ID listed first in the table and initializes a variable B for storing the similarity degree by 0.

Next, the similarity degree calculation unit 1003 calculates a similarity degree S between the phase string 503 associated with the past case ID stored in the variable A and the phase string 702 of the PC 112, in step S3002.

Specifically, the similarity degree S is calculated, using the following equation when a function for calculating a Levenshtein edit distance is indicated by D, the phase string 503 associated with the past case ID in the variable A is indicated by P1, and the phase string 702 of the PC 112 is indicated by P2.

The function for calculating a Levenshtein edit distance is configured to calculate an edit distance between two character strings with insertion, deletion, or substitution used as one edit operation.

With respect to the following equation, |x| indicates the length of a character string x, and Max ( ) indicates a function for returning one of a plurality of arguments having a largest argument value.

$$S = 1 - \frac{D ( P 1 , P 2 )}{Max ( \vert P 1 \vert , \vert P 2 \vert )} \qquad [ Equation 1 ]$$

Next, the similarity degree calculation unit 1003 determines whether the similarity degree S calculated in step S3002 is larger than the similarity degree in the variable B, in step S3003.

If the similarity degree S is larger than the similarity degree in the variable B in step S3003, the similarity degree calculation unit 1003 updates the variable B and the case similarity degree 706 with respect to the PC 112 in the attack phase table 301 by the similarity degree S, and updates the past case ID 705 with respect to the PC 112 in the attack phase table 301 by the variable A, in step S3004.

Next, in step S3005, the similarity degree calculation unit 1003 checks whether the variable A is the past case ID listed last in the past case table 202. If the variable A is not the last past case ID, the similarity degree calculation unit 1003 updates the variable A to the next past case ID in the past case table 202, in step S3006. Then, the similarity degree calculation unit 1003 repeats the processes after step S3002.

On the other hand, if the variable A is the last past case ID in the past case table 202 in step S3005, the similarity degree calculation unit 1003 next executes step S3007.

In step S3007, the similarity degree calculation unit 1003 respectively initializes a variable C for storing the scenario ID 601 in the attack scenario table 203 by 0001 that is the ID listed first in the table and initializes a variable E for storing the similarity degree by 0.

Next, the similarity degree calculation unit 1003 calculates a similarity degree S between the phase string 603 associated with the scenario ID in the variable C and the phase string 702 of the PC 112, in step S3008.

The similarity degree S is calculated using the same equation as in step S3002

Next, the similarity degree calculation unit 1003 determines whether the similarity degree S calculated in step S3008 is larger than the similarity degree in the variable E, in step S3009.

If the similarity degree S is larger than the similarity degree stored in the variable E in step S3009, the similarity degree calculation unit 1003 updates the scenario similarity degree 708 with respect to the PC 112 in the attack phase table 301 and the variable E by the similarity degree S, and updates the scenario ID 707 with respect to the PC 112 in the attack phase table 301 by the value of the variable C, in step S3010.

Next, the similarity degree calculation unit 1003 checks whether the variable A is the past case ID listed last in the attack scenario table 203 in step S3011. If the variable A is not the last scenario ID, the similarity degree calculation unit 1003 updates the variable C to the next scenario ID in the attack scenario table 203, in step S3012. Then, the similarity degree calculation unit 1003 repeats the processes after step S3008.

On the other hand, if the variable C is the last scenario ID in the attack scenario table in step S3011, the similarity degree calculation unit 1003 finishes the process.

FIGS. 15 to 17 describe the process in step S1003 in detail.

In step S4001, the attack status visualization unit 1004 sets 0001 in a variable F for the device ID, and initializes four counters N1 to N4 to 0 (see FIG. 15).

Next, in step S4002, the attack status visualization unit 1004 checks whether the device ID in the variable F is larger than the last device ID (see FIG. 15).

If the device ID of the variable F is larger than the last device ID in step S4002, the attack status visualization unit 1004 respectively displays values of the counters N1 to N4 on the total number displays 803 of the phases 1 to 4, in step S4025 (see FIG. 15).

If the device ID of the variable F is not larger than the last device ID in step S4002, the attack status visualization unit 1004 changes a subsequent process according to the value of the maximum phase 703 in step S4003.

If the maximum phase 703 is 1, the attack status visualization unit 1004 determines whether the past case display selection box 804 of the phase 1 has been checked, in step S4004 (see FIG. 16).

If the past case display selection box 804 has been checked in step S4004, the attack status visualization unit 1004 draws the reference symbol ‘Δ’ at a position corresponding to the value of the case similarity degree 706 in the similarity degree display region 806 of the phase 1, in step S4005 (see FIG. 16).

Next, the attack status visualization unit 1004 determines whether the attack scenario display selection box 805 of the phase 1 has been checked, in step S4006 (see FIG. 16).

If the attack scenario display selection box 805 has been checked in step S4006, the attack status visualization unit 1004 draws ‘□’ at a position corresponding to the value of the scenario similarity degree 708 in the similarity degree display region 806 of the phase 1, in step S4007 (see FIG. 16).

Next, the attack status visualization unit 1004 increments the counter N1 by 1 in step S4008 (see FIG. 16).

Then, the attack status visualization unit 1004 increments the variable F that stores the device ID by 1 in step S4024, and then repeats the processes after S4002.

Also if the maximum phase is 2, 3, or 4 in step S4003, the attack status visualization unit 1004 performs similar processes, as in FIGS. 16 and 17.

Since the operation of the attack status visualization unit 1004 is the same also if the maximum phase is 2, 3, or 4, description of the operation of the attack status visualization unit 1004 will be omitted.

Meanwhile, if the maximum phase is 0 in step S4003, the attack status visualization unit 1004 increments the variable F that stores the device ID by 1 in step S4024, and repeats the processes after step S4002.

FIG. 18 explains a process when the security growth process display screen 901 is displayed. The security growth process display screen 901 is displayed when the reference symbol Δ or □ displayed on display of security threat distributions in FIG. 10 is selected by the mouse 107.

In step S5001, the attack status visualization unit 1004 obtains from the attack phase table 301 the phase string 702 with respect to the device ID that has been selected.

Next, in step S5002, the attack status visualization unit 1004 displays a graph in the growth process display region 902, according to the phase string 702 obtained before.

Next, in step S5003, the attack status visualization unit 1004 checks whether the symbol with respect to the past case is selected.

If it is found out that the symbol with respect to the past case is selected in the check of step S5003, the attack status visualization unit 1004 obtains from the attack phase table 301, the past case ID 705 with respect to the selected device ID, in step S5004.

Next, in step S5005, the attack status visualization unit 1004 obtains from the past case table 202 the phase string 503 corresponding to the past case ID 705.

Next, in step S5006, the attack status visualization unit 1004 displays a graph in the growth process display region 902 according to the phase string 503.

Next, in step S5007, the attack status visualization unit 1004 displays the case similarity degree 706 on the similarity degree display 903, and finishes the process.

If the symbol with respect to the past case is not selected in step S5003, the attack status visualization unit 1004 executes processes from step S5008 to step S5011, displays a graph in the growth process display region 902 according to the phase string 603, and displays the scenario similarity degree 708 on the similarity degree display 903 (description will be omitted because the processes are similar to those in step S5004 to step S5007.).

As described above, the threat visualization system according to this embodiment divides a threat growth process into the attack phases, and visualizes and displays the threat growth process, based on similarity with the past case or the attack scenario. Thus, a user may determine importance of a threat based on the similarity.

Since the threat visualization system according to this embodiment visualizes and displays the threat growth process, the user may grasp to what extent the threat is growing.

As described above, in this embodiment, the description has been given about a threat visualization method in which the threat in progress is displayed based on a similarity degree with the past case, for each phase, using the attack event table and the past case table. In the attack event table, each threat is sorted out into one of the attack phases. In the past case table, events that occurred in each past case are recorded after being sorted out into one of the attack phases.

Further, in this embodiment, the description has been given about a threat visualization method in which the threat in progress is displayed based on a similarity degree with the attack scenario, for each phase, using the attack event table and the attack scenario table. In the attack event table, each threat is sorted out into one of the attack phases. In the attack scenario table, events that are predicted to occur based on each attack scenario are recorded after being sorted out into one of the attack phases.

In this embodiment, the description has been given about a threat visualization method in which each device where a threat in progress has occurred is totalized and displayed, for each phase of an attack that made intrusion.

In this embodiment, the description has been given about a threat visualization method in which a threat growth process is displayed together with the growth process of the similar past case in the form of graphs.

In this embodiment, the description has been given about a threat visualization method in which a threat growth process is displayed together with the growth process of the similar attack scenario in the form of graphs.

### REFERENCE SIGNS LIST

100: threat visualization system, 1001: table storage unit, 1002: phase string generation unit, 1003: similarity degree calculation unit, 1004: attack status visualization unit, 1005: input unit, 1006: output unit, 1007: communication unit

1. An information processing apparatus comprising:
an attack event table storage unit that stores an attack event table indicating, for each of a plurality of events caused from an attack on an information system, a progress degree of the attack at a time when each event occurs;
an attack event progress degree string table storage unit that stores an attack event progress degree string table indicating a character string as an attack event progress degree string, the character string being obtained by concatenating the progress degrees of corresponding events according to an occurrence pattern of events in an attack sequence;
an occurred event progress degree string derivation unit that concatenates the progress degrees of corresponding events according to the occurrence pattern of the events that have occurred in the information system, and derives an occurred event progress degree string that is a character string;
a similarity degree calculation unit that calculates a similarity degree between the occurred event progress degree string derived by the occurred event progress degree string derivation unit and the attack event progress degree string indicated in the attack event progress degree string table; and
an attack status visualization unit that visualizes a progress status of the attack on the information system, based on the occurred event progress degree string obtained by the occurred event progress degree string derivation unit and a result of calculation of the similarity degree by the similarity degree calculation unit.

2. The information processing apparatus according to claim 1,
wherein the attack event progress degree string table storage unit stores the attack event progress degree string table indicating the character string as the attack event progress degree string, for each of a plurality of attack sequences, the character string being obtained by concatenating the progress degrees of corresponding events according to the occurrence pattern of events in each attack sequence;
wherein the similarity degree calculation unit calculates the similarity degree between the occurred event progress degree string derived by the occurred event progress degree string derivation unit and each of a plurality of the attack event progress degree strings indicated in the attack event progress degree string table; and
wherein the attack status visualization unit extracts a maximum progress degree out of the progress degrees included in the occurred event progress degree string derived by the occurred event progress degree string derivation unit,
extracts a maximum similarity degree out of a plurality of the similarity degrees calculated by the similarity degree calculation unit, and
visualizes the progress status of the attack on the information system, using the maximum progress degree extracted and the maximum similarity degree extracted.

3. The information processing apparatus according to claim 2,
wherein the information processing apparatus targets an information system including a plurality of terminal devices;
wherein the occurred event progress degree string derivation unit concatenates, for each terminal device included in the information system, the progress degrees of corresponding events according to the occurrence pattern of events that have occurred, and derives the occurred event progress degree string that is the character string;
wherein the similarity degree calculation unit calculates, for each terminal device, the similarity degree between the occurred event progress degree string derived by the occurred event progress degree string derivation unit and each of the plurality of the attack event progress degree strings indicated in the attack event progress degree string table; and
wherein the attack status visualization unit extracts, for each terminal device, the maximum progress degree out of the progress degrees included in the occurred event progress degree string derived by the occurred event progress degree string derivation unit,
extracts, for each terminal device, the maximum similarity degree out of the plurality of the similarity degrees calculated by the similarity degree calculation unit, and
visualizes the progress status of the attack on the information system, using the maximum progress degree and the maximum similarity degree extracted for each terminal device.

4. The information processing apparatus according to claim 3,
wherein the attack status visualization unit plots a relationship between the maximum progress degree and the maximum similarity degree extracted for each terminal device and displays graphs indicating distributions of the maximum progress degrees and the maximum similarity degrees of the plurality of terminal devices, and visualizes the progress of the attack on the information system.

5. The information processing apparatus according to claim 4,
wherein the attack status visualization unit displays, for each progress degree, the number of the terminal devices whose maximum progress degrees are the progress degree in question, and visualizes the progress status of the attack on the information system.

6. The information processing apparatus according to claim 1,
wherein the information processing apparatus targets the information system including the plurality of terminal devices;
wherein the attack event progress degree string table storage unit stores the attack event progress degree string table indicating the character string as the attack event progress degree string for each of the plurality of attack sequences, the character string being obtained by concatenating the progress degrees of the corresponding events according to the occurrence pattern of the events in each attack sequence;
wherein the occurred event progress degree string derivation unit concatenates, for each terminal device included in the information system, the progress degrees of the corresponding events according to the occurrence pattern of the events that have occurred in each terminal device, and derives the occurred event progress degree string that is the character string;
wherein the similarity degree calculation unit calculates, for each terminal device, the similarity degree between the occurred event progress degree string obtained by the occurred event progress degree string derivation unit and each of the plurality of the attack event progress degree strings indicated in the attack event progress degree string table; and
wherein the attack status visualization unit selects the attack event progress degree string used for calculating a maximum similarity degree out of the plurality of the similarity degrees calculated for a specific terminal device, and
displays graphs indicating a progress degree transition in the occurred event progress degree string of the specific terminal device and a progress degree transition in the attack event progress degree string selected, and visualizes the progress status of the attack on the information system.

7. The information processing apparatus according to claim 1,
wherein the attack event progress degree string table storage unit stores the attack event progress degree string table indicating the attack event progress degree string for an attack sequence of a past attack.

8. The information processing apparatus according to claim 1,
wherein the attack event progress degree string table storage unit stores the attack event progress degree string table indicating the attack event progress degree string for an attack sequence of an assumed attack.

9. An information processing method to be performed by a computer that includes;
an attack event table storage unit that stores an attack event table indicating, for each of a plurality of events caused from an attack on an information system, a progress degree of the attack at a time when each event occurs, and
an attack event progress degree string table storage unit that stores an attack event progress degree string table indicating a character string as an attack event progress degree string, the character string being obtained by concatenating the progress degrees of corresponding events according to an occurrence pattern of events in an attack sequence,
the information processing method comprising:
by the computer, concatenating the progress degrees of corresponding events according to the occurrence pattern of the events that have occurred in the information system, and deriving an occurred event progress degree string that is a character string;
by the computer, calculating a similarity degree between the occurred event progress degree string derived and the attack event progress degree string indicated in the attack event progress degree string table; and
by the computer, visualizing a progress status of the attack on the information system, based on the occurred event progress degree string derived and a result of calculation of the similarity degree.

10. A program that causes a computer to function as the information processing apparatus according to claim 1.
